(19) United States
(12) Patent Application Publication
(10) Pub. No.: US 2026/0308966 A1
(43) Pub. Date: Oct. 8, 2026

(54) METHOD OF CONTROLLING AN ELECTRIC MOTOR FOR MOVING AT LEAST ONE MOVABLE DOOR OF A PIECE OF FURNITURE, AND PIECE OF FURNITURE ADAPTED TO IMPLEMENT SUCH A METHOD

(71) Applicant: Arturo Salice S.p.A., Novedrate (IT)

(72) Inventor: Sergio Salice, Novedrate (IT)

(73) Assignee: Arturo Salice S.p.A., Novedrate, CO (IT)

(21) Appl. No.: 19/482,034

(22) PCT Filed: May 9, 2024
(86) PCT No.: PCT/IB2024/054514

§ 371 Date: Nov. 6, 2025

(30) Foreign Application Priority Data
May 9, 2023 (IT) 102023000009198

(51) Int. Cl. E05F 15/605; E05D 15/26

(52) U.S. Cl. CPC E05F 15/605; E05D 15/264; E05Y 2400/36; E05Y 2900/212

(57) ABSTRACT

A method of controlling an electric motor for moving a movable door of a piece of furniture is described, bringing a translatable command element, to which the door is connected, from a resting position to a so-called cruising speed. As the distance covered by the translatable command element does not exceed a set first reference distance value, the method performs only the following of the set first feed speed value, executing no further control of the rotation speed of the electric motor. After exceeding the set first reference distance value, the method controls whether the value representative of the feed speed goes below a set first reference speed value. If this condition is met, the method electrically disconnects the electric motor until the translatable command element goes back by a distance equal to a set second reference distance value. The method then performs the following of a set second feed speed value until the first resting position is reached.

### FIELD OF THE INVENTION

The present invention relates to the field of furniture, in particular to a method of controlling an electric motor for moving at least one movable door of a piece of furniture, and a piece of furniture adapted to implement such a method.

### TECHNOLOGICAL BACKGROUND OF THE INVENTION

There are known pieces of furniture with sliding and foldable doors to allow a reduction in the volume of the doors in the opening position, thus avoiding the drawbacks of hinged doors.

For example, a piece of furniture is known comprising a front opening and two movable and oscillating doors for closing the front opening.

The two doors are hinged to each other.

Such a piece of furniture is provided with two substantially L-shaped guides, which are parallel to each other, each comprising a first linear segment and a second linear segment, joined to each other, wherein the first linear segment is parallel to an edge of the front opening, while the second linear segment is substantially orthogonal to the first linear segment and arranged at an outer side of the piece of furniture, along the depth of the compartment.

A door is slidingly coupled to the guides by means of a bracket adapted to engage with the guides by means of respective pins. Such a door, guided by the bracket, is adapted to also move the other door by an oscillating coupling by means of a hinge.

Such a piece of furniture is further provided with a manually-operable control element, which is translatable parallel along said outer side.

The door, which is not connected to the bracket, is operatively connected in an oscillating manner to the translatable command element so that the two doors are pulled with respect to the front opening during the manual movement of said translatable command element for opening or closing said front opening.

A clear limit of the above piece of furniture is undoubtedly related to the fact that the manual operation requires physical force to move the translatable command element and, indirectly, the sliding doors pulled and connected thereto.

Moreover, particular care and attention is required upon actuation to avoid sudden movements, which can damage the sliding doors and/or translatable command element and/or the guide inside which the sliding doors slide or other unexpected movements, which can cause knocking between the different components, which, besides potential damage, could cause undesired noise, generally making the piece of furniture poorly secure as a whole.

### SUMMARY

It is the object of the present invention to conceive and provide a method of controlling an electric motor for moving at least one movable door of a piece of furniture, which allows overcoming, at least partially, the above drawbacks with reference to the prior art and which is capable of significantly reducing the physical effort made by a user, ensuring an opening/closing movement, which is as controlled and uniform as possible, with a reduction in the noise associated therewith while maintaining an adequate level of safety.

Such an object is achieved by a method of controlling an electric motor for moving at least one movable door of a piece of furniture, the piece of furniture comprising: a body adapted to define a compartment with a front opening; at least one movable and oscillating door for closing the front opening of the compartment; at least one substantially L-shaped guide comprising a first linear segment and a second linear segment joined to each other, the first linear segment being parallel to an edge of the front opening, the second linear segment being substantially orthogonal to the first linear segment and being arranged at an outer side of the body of the piece of furniture along the depth of the compartment, a side edge of the at least one door being slidingly coupled to the at least one guide by means of an auxiliary coupling element adapted to slidingly engage the at least one guide by means of at least a first pin; a command element translatable parallelly to and along said outer side, the at least one door being operatively connected in an oscillating manner to the translatable command element to be pulled with respect to the front opening during the movement of said translatable command element for opening or closing said front opening; a data processing unit; an electric motor operatively connected to the translatable command element and to the data processing unit, said electric motor being commandable by the data processing unit to move the translatable command element. The method comprises: moving, by the electric motor, the translatable command element upon the command received by the data processing unit at a set first feed speed value, from a first resting position in which the translatable command element is arranged in front of the outer side of the body of the piece of furniture and does not extend frontally from the piece of furniture; controlling, by the data processing unit, the electric motor so that the translatable command element maintains the set first feed speed value; determining, by the data processing unit, a value representative of the distance covered by the translatable command element with respect to the first resting position, parallel to the outer side of the body of the piece of furniture; comparing, by the data processing unit, the detected value representative of the distance covered by the translatable command element with respect to the first resting position with a set first reference distance value to verify whether the translatable command element has reached a second operating position or not, in which such a translatable command element extends substantially at most frontally from the piece of furniture. If the determined value representative of the distance covered by the translatable command element with respect to the first resting position is less than the set first reference distance value, the method comprises controlling, by the data processing unit, the electric motor so that the translatable command element maintains the set first feed speed value. If the determined value representative of the distance covered by the translatable command element with respect to the first resting position is equal to or greater than the set first reference distance value, the method controls: determining, by the data processing unit, a value representative of the feed speed of the translatable command element with respect to the first resting position; comparing, by the data processing unit, the determined value representative of the feed speed of the translatable command element with respect to the first resting position with a set first reference speed value. If the determined value representative of the feed speed of the translatable command element with respect to the first resting position is greater than the set first reference speed value, the method comprises controlling, by the data processing unit, the electric motor so that the translatable command element maintains the set first feed speed value. If the determined value representative of the feed speed of the translatable command element with respect to the first resting position is equal to or less than the set first reference speed value, the method comprises: interrupting, by the data processing unit, the power supply of the electric motor so that the translatable command element moves, under the action of a counterweight, in the opposite direction from the second operating position towards the first resting position; determining, by the data processing unit, a value representative of the distance covered by the translatable element with respect to the second operating position; comparing, by the data processing unit, the determined value representative of the distance covered by the translatable command element with respect to the second operating position with a set second reference distance value. If the determined value representative of the distance covered by the translatable command element with respect to the second operating position is greater than the set second reference distance value, the method comprises keeping the power supply of the electric motor interrupted by the data processing unit. If the determined value representative of the distance covered by the translatable element with respect to the second operating position is equal to or less than the set second reference distance value, the method comprises: electrically powering, by the data processing unit, the electric motor to move the translatable command element towards the first resting condition; controlling, by the data processing unit, the electric motor so that the translatable command element maintains a set second feed speed value until reaching the first resting position.

The present invention relates to a piece of furniture adapted to implement such a method.

### BRIEF DESCRIPTION OF THE DRAWINGS

Further features and advantages of the method and piece of furniture according to the invention will be apparent from the following description of preferred embodiments, given by way of non-limiting indication, with reference to the accompanying drawings, in which:

FIG. 1 shows a perspective view of a piece of furniture according to the present invention;

FIG. 2 illustrates a side view of the piece of furniture in FIG. 1;

FIGS. 3a-3e show the piece of furniture in FIG. 1 in successive operating configurations during a step of opening the piece of furniture;

FIG. 3f shows a side view of the piece of furniture in FIG. 1 in an operating configuration during a step of opening or closing the piece of furniture;

FIGS. 4a-4f diagrammatically show top view of a piece of furniture according to the present invention in successive operating configurations during a step of opening the piece of furniture;

FIGS. 5a-5f diagrammatically show top views of the piece of furniture in FIGS. 4a-4f in successive operating configurations during a step of closing the piece of furniture;

FIG. 6 shows, by means of a block diagram, electrical/electronic components of the piece of furniture according to the present invention;

FIG. 7 shows, by means of a block diagram, a method of controlling an electric motor for moving at least one movable door of a piece of furniture according to the present invention;

FIGS. 8a-8f diagrammatically show top views of a further piece of furniture according to the present invention in successive operating configurations during a step of opening the piece of furniture, and

FIGS. 9a-9f diagrammatically show top views of the further piece of furniture in FIGS. 8a-8f in successive operating configurations during a step of closing the piece of furniture.

### DETAILED DESCRIPTION

With reference to the above figures, a piece of furniture 100 is now described, adapted to implement the method of controlling an electric motor for moving at least one movable door of a piece of furniture.

The piece of furniture 100 comprises a body 1 adapted to define a compartment 2 with a front opening 3.

In greater detail, the compartment 2 defines a space, which is open towards the outside, delimited by a bottom wall, a first lower horizontal wall and a second upper horizontal wall, a first lateral vertical wall and a second lateral vertical wall.

In the example in the figures, the first lower horizontal wall and the second upper horizontal wall are spaced apart from each other by the height of the compartment 2, while the first lateral vertical wall and the second lateral vertical wall are spaced apart from each other by the width of the compartment 2.

The piece of furniture 100 further comprises at least one movable and oscillating door 4 for opening or closing the front opening 3 of the compartment 2.

The piece of furniture 100 further comprises at least one substantially L-shaped guide 5 comprising a first linear segment L1 and a second linear segment L2, joined to each other.

The first linear segment L1 is parallel to an edge of the front opening 3.

The second linear segment L2 is substantially orthogonal to the first linear segment L1 and is arranged at an outer side 6 of the body 1 of the piece of furniture 100 along the depth of the compartment 2.

The outer side 6 corresponds, for example to one from the first vertical side wall and the second vertical side wall.

A side edge, for example the upper one, of the at least one door 4 is slidingly coupled to the guide 5.

In greater detail, as shown in the figures, the upper edge of the at least one door 4 is operatively slidingly coupled to the at least one guide 5 by means of an auxiliary coupling element 7.

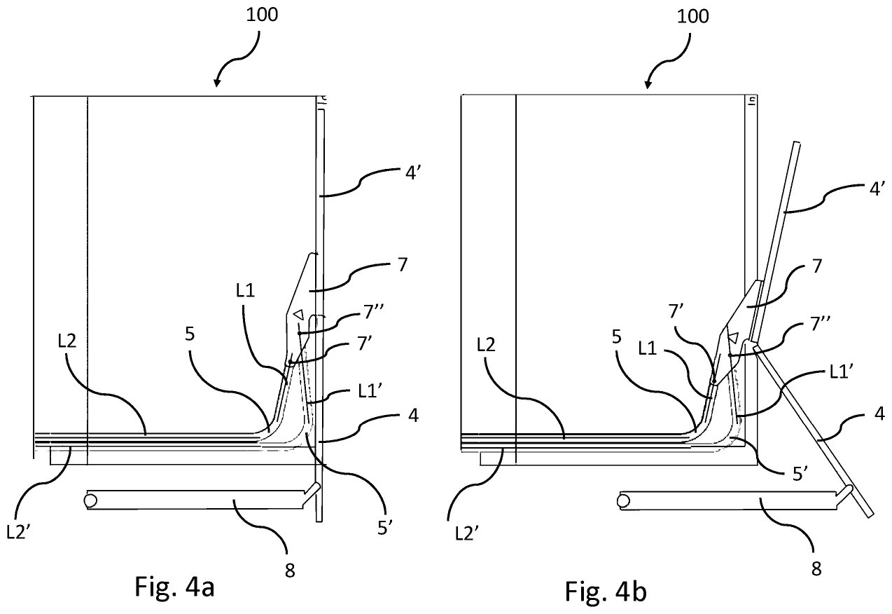

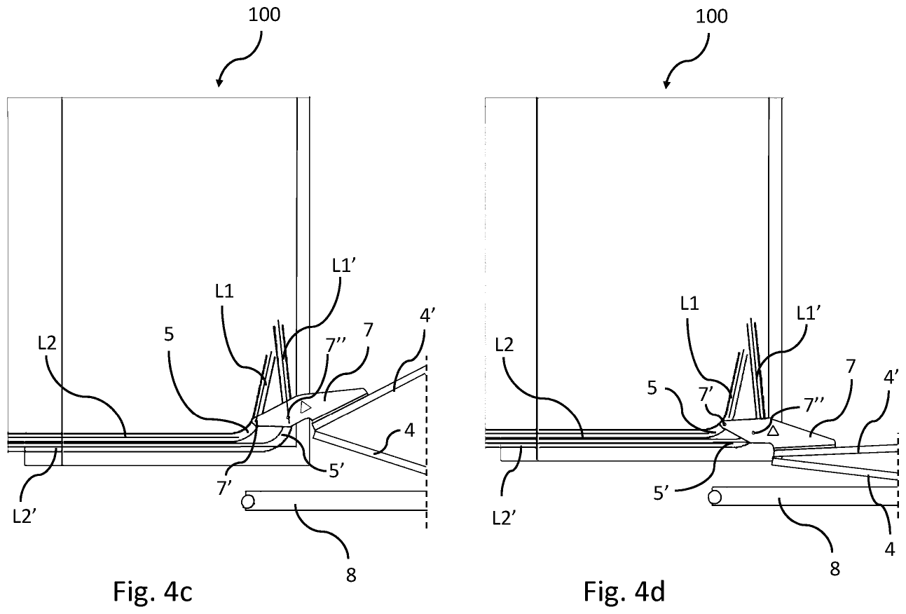

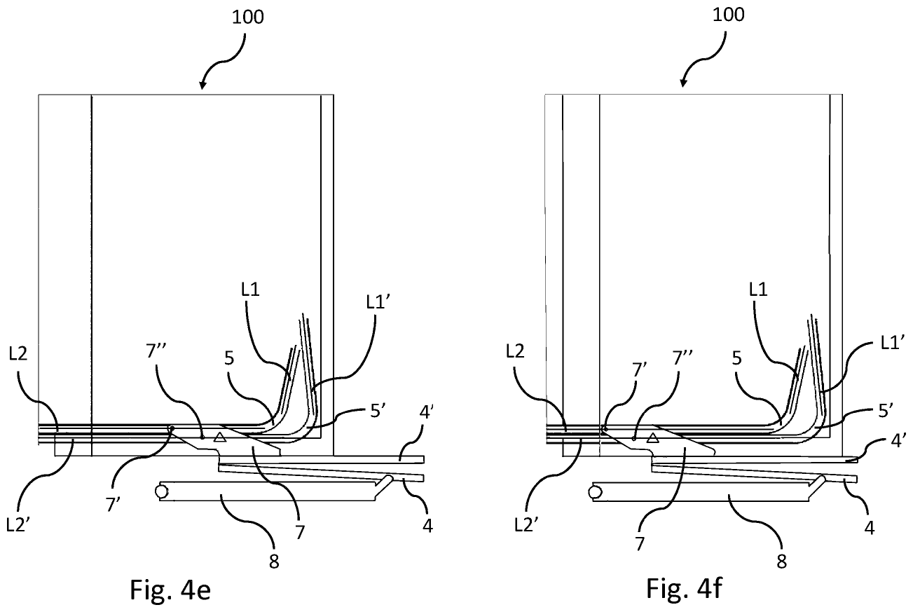

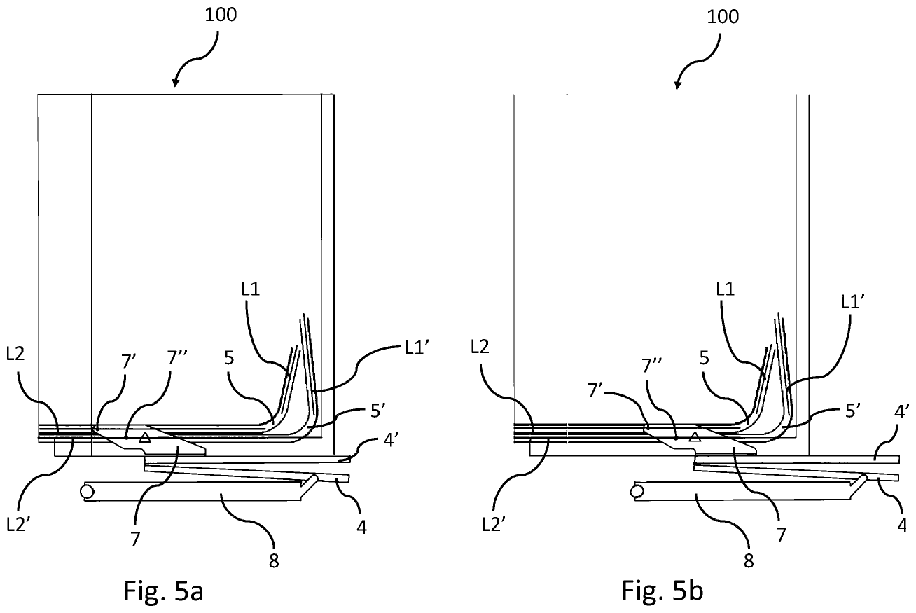

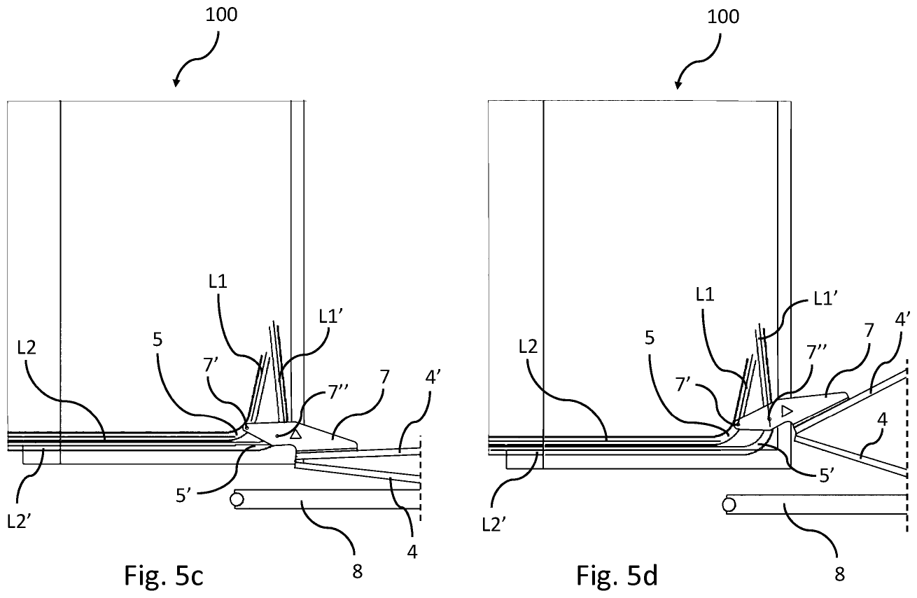

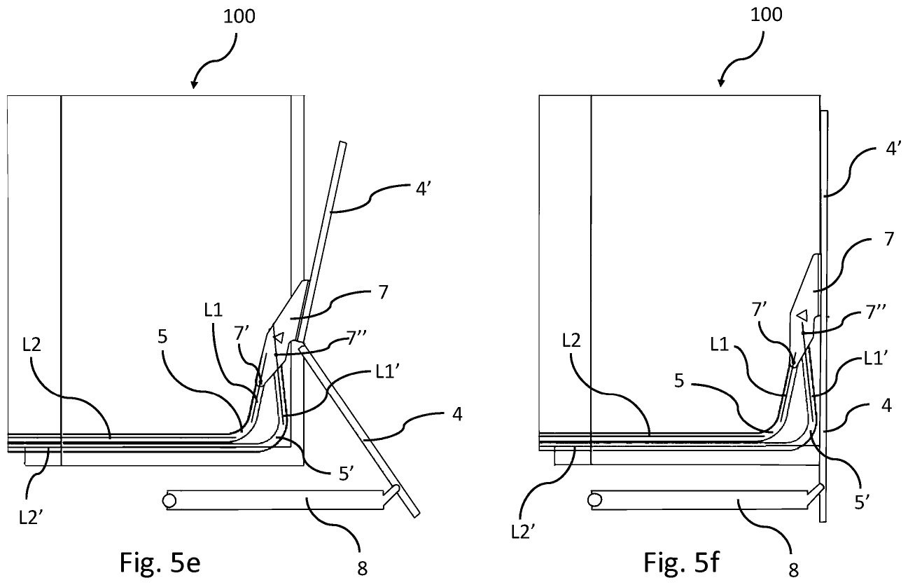

In particular, the auxiliary coupling element 7, e.g., a bracket, is adapted to slidingly engage with the at least one guide 5 by means of at least a first pin 7′ (diagrammatically shown in the FIGS. 4a-4f and 5a-5f).

According to an embodiment, in combination with the preceding one and shown in the figures, the piece of furniture 100 further comprises a second substantially L-shaped guide 5′ comprising a further first linear segment L1′ and a further second linear segment L2′, joined to each other.

The further first linear segment L1′ is parallel to the edge of the front opening 3, therefore, also to the first linear segment L1 of the at least one guide 5.

Also in this case, the further second linear segment L2′ is substantially orthogonal to the further first linear segment L1′ and is arranged at the outer side 6 of the body 1 of the piece of furniture 100 along the depth of the compartment 2.

In fact, the second guide 5′ substantially extends parallel to the at least one guide 5.

In this embodiment, as shown in the figures, the upper edge of the at least one door 4 is slidingly coupled to the at least one guide 5 and to the second guide 5′ by means of the auxiliary coupling element 7.

In greater detail, the auxiliary coupling element 7 is adapted to slidingly engage with the at least one guide 5 by means of at least the first pin 7′ and with the second guide 5′ by means of a second pin 7″ (diagrammatically shown in FIGS. 4a-4f and 5a-5f).

Going back to the present invention in general, the piece of furniture 100 further comprises a translatable command element 8 operatively connected to the body 1 of the piece of furniture 100 and adapted to slide parallel to, and along said outer side 6 of the body 1 of the piece of furniture 100.

In greater detail, as shown in the figures, the translatable command element 8 is operatively connected to the outer side 6 of the body 1 of the piece of furniture 100 by means of a mechanical drive kinematism C-T of the motion adapted to slidingly engage with the translatable command element 8 (e.g., adapted to slide vertically along one of the uprights) and with respective sliding guides 9, preferably parallel and inclined with respect to the horizontal, arranged on the outer side 6 of the body 1 of the piece of furniture 100.

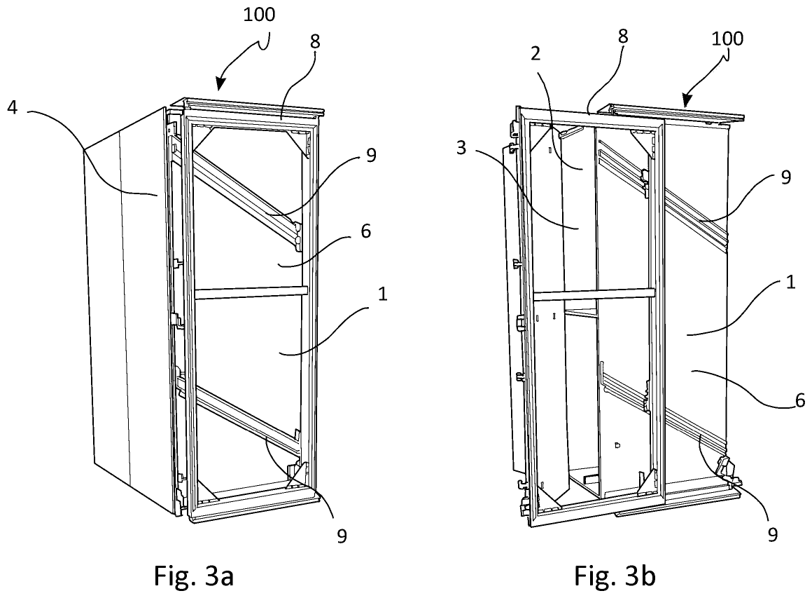

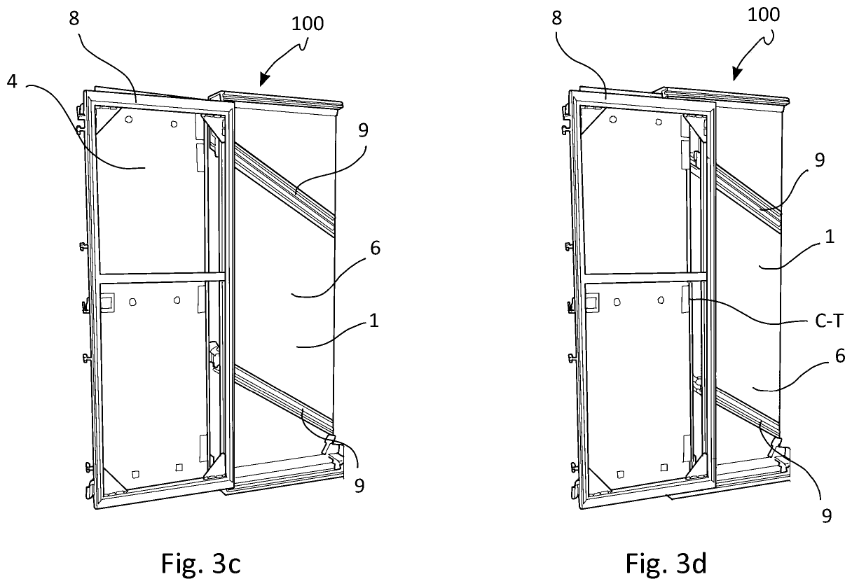

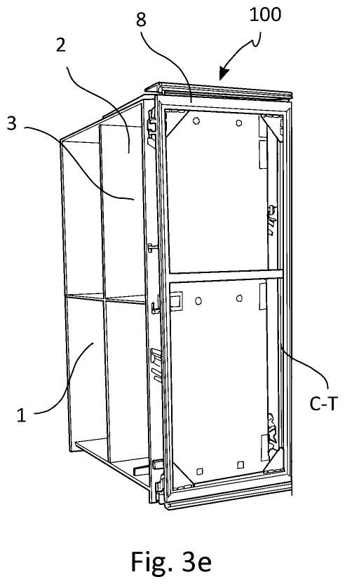

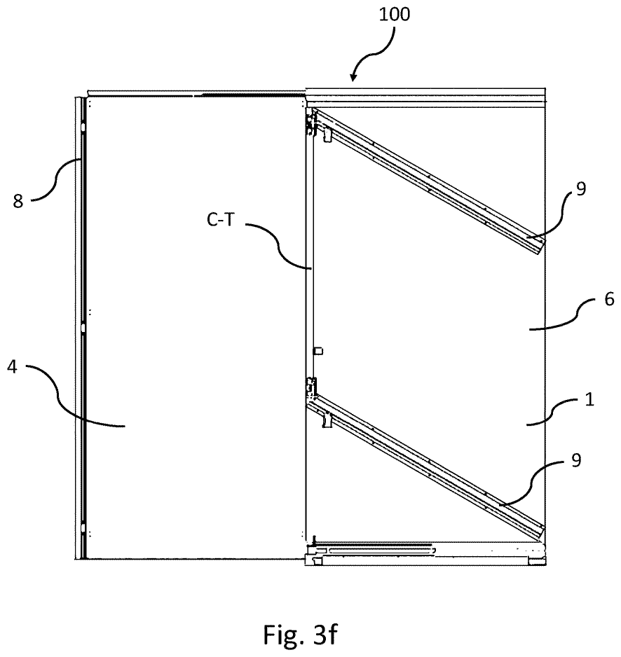

As shown, for example in FIGS. 3d, 3e and 3f, the mechanical drive kinematism C-T of the motion comprises a vertical bar having, in each end, a first component shaped to be coupled and slide along one of the uprights of the translatable command element 8 and a second component shaped to slide along a respective one of the two sliding guides 9, arranged on the outer side 6 of the body 1 of the piece of furniture 100.

In particular, the mechanical drive kinematism is operable by an electric motor (described hereinafter) by means of a drive mechanism of the belt-pulley type motion, to allow the mechanical drive kinematism of the motion to slide along the translatable command element 8 and along the respective sliding guides 9, consequently causing the translatable command element 8 to slide parallel to, and along said outer side 6 of the body 1 of the piece of furniture 100.

Note that advantageously, the mechanical drive kinematism of the motion, connected both to the translatable command element 8 and to the outer side 6 of the piece of furniture 100, allows preventing the accidental overturning of the translatable command element 8 even though such a mechanical drive kinematism of the motion has the tendency, during the movement of the translatable command element 8, to move down, also pulling the translatable command element 8 therewith.

Moreover, Advantageously, the Mechanical Drive kinematism of the motion represents a counterweight, which tends to bring the translatable command element 8 back to the resting position, as will be reiterated hereinafter.

Again, when the translatable command element 8 is free from the action of the electric motor 12 (electric motor 12 electrically disconnected, as described below), it is manually movable.

The at least one door 4 is operatively connected in an oscillating manner to the translatable command element 8 to be pulled with respect to the front opening 3 during the movement of said translatable command element 8 for opening or closing said front opening 3.

The translatable command element 8, as shown in the figures, is a frame, for example configured to house therein the at least one door 4, when the translatable command element 8 is in a specific resting position, as will be described hereinafter.

In fact, the at least one door 4, during the movement of the translatable command element 8, by virtue of the shape of the auxiliary coupling element 7, is adapted to be moved by the auxiliary coupling element 7 with respect to the at least one guide 5 (and the second guide 5′, if present) so as to switch from a position, in which the at least one door 4 is arranged covering the front opening 3 (closing of the piece of furniture 100) to a position, in which the at least one door 4 is arranged inside the translatable command element 8, when the latter is in a resting position (as will be described hereinafter), leaving open the front opening 3 (opening of the piece of furniture 100) and, vice versa, to switch from the position, in which the at least one door 4 is arranged inside the translatable command element 8, when the latter is in the specific resting position, leaving open the front opening 3 (opening of the piece of furniture 100) to the position, in which the at least one door 4 is arranged covering the front opening 3 (closing of the piece of furniture 100).

In a further embodiment, in combination with any one of those described previously and shown in the figures, the piece of furniture 100 further comprises a second movable and oscillating door 4′ for opening or closing, together with the at least one door 4, the front opening 3 of the compartment 2.

In greater detail, the second door 4′ is operatively connected in an oscillating manner, e.g., by means of a hinge, to the at least one door 4 to be pulled, by the at least one door 4, with respect to the front opening 3 during the movement of said translatable command element 8 for opening or closing said front opening 3.

In other words, the at least one door 4 and the second door 4′ can extend and fold in front of the compartment 2 to close the front opening 3 or leave the compartment 2 accessible from the outside.

In this embodiment, the translatable command element 8, as shown in the figures, is a frame, for example configured to accommodate therein the at least one door 4 and the second door 4′, folded or “packed” with respect to each other, when the translatable command element 8 is in the specific resting position, as will be described hereinafter.

In this embodiment, as shown in the figures, the upper edge of the at least one door 4 and the upper edge of the second door 4′ are slidingly coupled to the at least one guide 5 and to the second guide 5′ by means of the auxiliary coupling element 7.

In greater detail, in this embodiment, as shown in the figures, the second door 4′ is secured to the auxiliary coupling element 7, while the at least one door 4 is indirectly connected to the auxiliary coupling element 7 by means of the connection thereof, e.g., by means of the hinge, to the second door 4′.

In other words, the second door 4′ is guided by the auxiliary coupling element 7 while the at least one door 4 is moved by the second door 4′.

Dually, the at least one door 4 is guided by the translatable command element 8, while the second door 4′ is moved by the at least one door 4.

In this embodiment, the at least one door 4 and the second door 4′, during the movement of the translatable command element 8, by virtue of the shape of the auxiliary coupling element 7, are adapted to be moved by the auxiliary coupling element 7 with respect to the at least one guide 5 (and to the second guide 5′, if present) so as to switch from a position, in which the at least one door 4 and the second door 4′ are arranged next to each other, covering the front opening 3 (closing of the piece of furniture 100) to a position, in which the at least one door 4 and the second door 4′ are arranged facing each other, thus folded or “packed”), inside the translatable command element 8, when the latter is in a resting position (as will be described hereinafter), leaving open the front opening 3 (opening of the piece of furniture 100) and, vice versa, to switch from the position, in which the at least one door 4 and the second door 4′ are arranged inside the translatable command element 8, when the latter is in the specific resting position, leaving open the front opening 3 (opening of the piece of furniture 100) to the position, in which the at least one door 4 and the second door 4′ are arranged next to each other, covering the front opening 3 (closing of the piece of furniture 100).

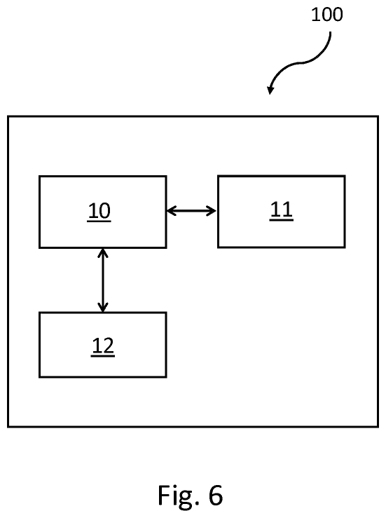

Going back to the present invention in general, with particular reference to FIG. 6, the piece of furniture 100 comprises a data processing unit 10, e.g., a microcontroller or a microprocessor.

The piece of furniture 100 further comprises a memory unit 11 operatively connected to the data processing unit 10.

The memory unit 11 can be outside (as shown diagrammatically in FIG. 6) or inside the data processing unit 10 (embodiment not shown in the figures).

By means of the loading and execution of one or more program codes, stored in the memory unit 10, the data processing unit 10 is configured to perform a method of controlling an electric motor for moving at least one movable door of a piece of furniture, as will be described hereinafter according to different embodiments of the present invention.

In this respect, the piece of furniture 100 further comprises an electric motor 12 operatively connected to the translatable command element 8 and to the data processing unit 10.

The electric motor 12 is commandable by the data processing unit 10 for moving the translatable command element 8.

In greater detail, the electric motor 12, for example a DC electric brush motor, is coupled to an electric reducer and, by means of a drive mechanism of the belt-pulley type-motion, to the mechanical drive kinematism C-T of the motion adapted to slidingly engage both with the translatable command element 8 and with the sliding guides 9 present on the outer side 6 of the body 1 of the piece of furniture 100.

The data processing unit 10, the memory unit 11 and the electric motor 12 are integrated, for example in an electronic board installed on the piece of furniture 100.

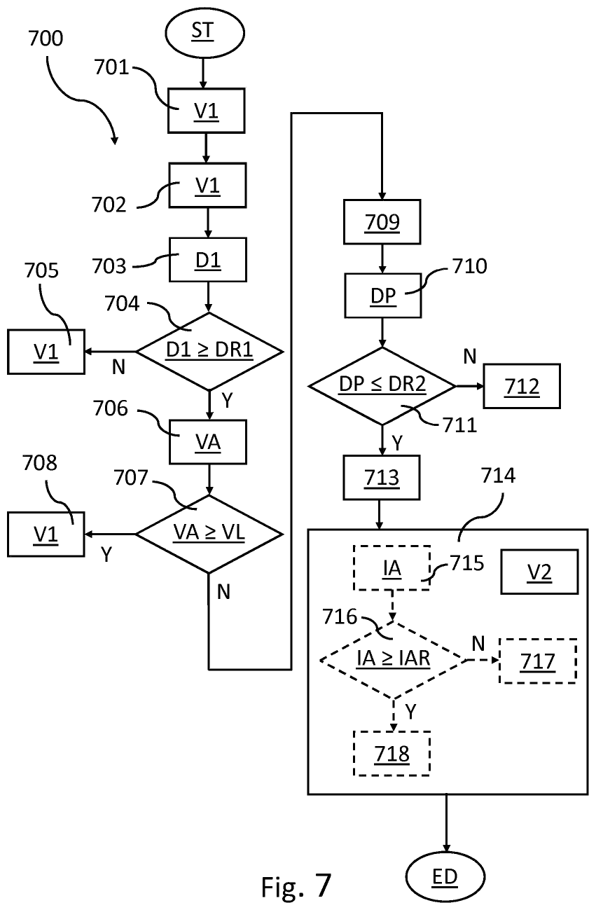

Now, with reference to the above figures and in particular to FIG. 7, a method 700 of controlling an electric motor for moving at least one movable door of a piece of furniture is now described, hereinafter also only control method or simply method, according to the present invention.

The essential components of the piece of furniture 100 were described previously and will not be repeated herein, for the sake of brevity.

The method comprises a symbolic step of starting ST.

The method 700 comprises a step of moving 701, by the electric motor 12 upon a command received by the data processing unit 10, the translatable command element 8 at a set first feed speed value V1 (e.g., equal to 100 mm/s), from a first resting position, in which the translatable command element 8 is arranged in front of the outer side 6 of the body 1 of the piece of furniture 100 and does not extend frontally from the piece of furniture 100 (e.g., FIGS. 3a, 4a, 5a).

The method 700 comprises a step of controlling 702, by the data processing unit 10, the electric motor 12 so that the translatable command element 8 maintains the first set feed speed value V1.

In Other words, the data processing unit 10 performs a following (i.e. the feedback control) of the first set feed speed value V1, i.e., it determines a value for each sampling instant of time, representative of the feed speed of the translatable command element 8 and, based on the comparison of such a detected value with the first set feed speed value V1, controls the rotation of the electric motor 12 so that the feed speed of the translatable command element 8 is effectively equal to the first set feed speed value V1.

In greater detail, the determination of the value representative of the feed speed of the translatable command element 8 is carried out, for example by the data processing unit 10 based on the information provided by a position sensor (e.g., an encoder) installed in the electric motor 12.

The method 700 comprises a step of determining 703, by the data processing unit 10, e.g., by means of the position sensor (encoder) installed in the electric motor 12, a value DI representative of the distance covered by the translatable command element 8 with respect to the first resting position, parallel to the outer side 6 of the body 1 of the piece of furniture 100.

The method 700 further comprises a step of comparing 704, by the data processing unit 10, the determined value D1 representative of the distance covered by the translatable command element 8 with respect to the first resting position with a set first reference distance value DR1 (e.g., equal to 300 mm), to verify whether the translatable command element 8 has reached a second operating position or not, in which such a translatable command element 8 substantially extends at most frontally from the piece of furniture 100 (e.g., FIGS. 3c, 4d, 5d).

Thereby, the method is capable of recognizing the exceeding of the so-called “dead center”, by the translatable command element 8, which aspect is essential for the movement of the translatable command element 8 to be complete and which is only achieved by bringing the at least one door 4 close to the inversion point with a determined amount of kinetic energy.

If the determined value D1 representative of the distance covered by the translatable command element 8 with respect to the first resting position is less than the set first reference distance value DR1, the method 700 comprises a step of controlling 705, by the data processing unit 10, the electric motor 12 so that the translatable command element 8 maintains the set first feed speed value V1.

In other words, the data processing unit 10 performs the following (i.e. the feedback control) of the set first feed speed value V1, for example, according to the previously described manner.

On the other hand, if the determined value D1 representative of the distance covered by the translatable command element 8 with respect to the first resting position is equal to, or greater than the set first reference distance value DR1, the method 700 comprises a step of determining 706, by the data processing unit 10, for example by means of the position sensor (encoder) installed in the electric motor 12, a value VA representative of the feed speed of the translatable command element 8 with respect to the first resting position.

Also in this case, the determination of the value VA representative of the feed speed of the translatable command element 8 is carried out, for example by the data processing unit 10 based on the information provided by the position sensor (e.g., an encoder) installed in the electric motor 12.

Successively, the method 700 further comprises a step of comparing 707, by the data processing unit 10, the determined value VA representative of the feed speed of the translatable command element 8 with respect to the first resting position with a set first reference speed value (VL) (e.g., equal to 60 mm/s).

It should be noted that the set first reference speed value VL is representative of a discriminating threshold value of the reverse point of the translatable command element 8.

If the determined value VA representative of the feed speed of the translatable command element 8 with respect to the first resting position is greater than the set first reference speed value VL, the method 700 comprises a step of controlling 708, by the data processing unit 10, the electric motor 12 so that the translatable command element 8 maintains the set first feed speed value V1.

In other words, also in this case, the data processing unit 10 performs the following (i.e. the feedback control) of the set first feed speed value V1, for example, according to the previously described manner.

On the contrary, if the determined value VA representative of the feed speed of the translatable command element 8 with respect to the first resting position is equal to, or less than the set first reference speed value VL (which means that the translatable command element 8 has reached the reverse point), the method 700 comprises steps of:
interrupting 709, by the data processing unit 10, the power supply of the electric motor 12 s that the translatable command element 8 moves, under the action of a counterweight (represented by the weight of the mechanical drive kinematism C-T of the motion by means of which the electric motor 12 is mechanically connected to the translatable command element 8), in the opposite direction from the second operating position towards the first resting position again;
determining 710, by the data processing unit 10, for example by means of the position sensor (encoder) installed in the electric motor 12, a value DP representative of the distance covered by the translatable command element 8 with respect to the second operating position;
comparing 711, by the data processing unit 10, the determined value DP representative of the distance covered by the translatable command element 8 with respect to the second operating position with a set second reference distance value DR2 (e.g., equal to 100 mm).

If the determined value DP representative of the distance covered by the translatable command element 8 with respect to the second operating position is greater than the set second reference distance value DR2, the method 700 comprises a step of keeping the power supply of the electric motor 12 interrupted 712 by the data processing unit 10.

If the determined value DP representative of the distance covered by the translatable command element with respect to the second operating position is equal to, or less than the set second reference distance value DR2, the method 700 comprises a step of electrically supplying 713 the electric motor 12, by the data processing unit 10, for moving the translatable command element 8 towards the first resting state again.

Moreover, in this state, the method 700 comprises a state of controlling 714, by the data processing unit 10, the electric motor 12, so that the translatable command element 8 maintains a set second feed speed value V2 until reaching the first resting position.

The method 700 comprises a symbolic ED step of ending.

Therefore, the method 700 allows bringing the translatable command element 8 from a resting position to a so-called cruising speed, i.e., the set first feed speed value V1 and, while the distance covered by the translatable command element 8 does not exceed the set first reference distance value DR1 (which can be considered a symbolic “ramp” value), the method 700 makes no further control of the rotation speed of the electric motor 12, but only performs the following (i.e. the feedback control) of the set first feed speed value V1.

After exceeding the set first reference distance value DR1, the method 700 controls whether the value VA representative of the feed speed by the translatable command element 8 goes below the set first reference speed value VL.

If so, the method 700 electrically disconnects the electric motor 12 until the translatable command element 8 goes back by a distance equal to the set second reference distance value DR2.

From that point on, the method 700 performs the following (i.e. the feedback control) of the set second feed speed value V2 until the translatable command element 8 reaches the first resting position.

According to an embodiment, shown with dotted lines in FIG. 7, the step of controlling 714 the electric motor 12 so that the translatable command element 8 maintains a set second feed speed value V2 until reaching the first resting position comprises steps of:
determining 715, by the data processing unit 10, a value IA representative of the electric current absorbed by the electric motor 12 during the operation thereof; in this respect, the data processing unit 10 is aware of such a value IA representative of the electric current absorbed by the electric motor 12 during the operation thereof;
comparing 716, by the data processing unit 10, the determined value IA representative of the electric current absorbed by the electric motor 10 during the operation thereof with a set reference absorption electric current value IAR (e.g., equal to 1 Ampere) in order to establish whether the translatable command element 8 has reached the first resting position or not.

If the determined value IA representative of the electric current absorbed by the electric motor 10 during the operation thereof is less than the set reference absorption electric current value IAR, the method 700 comprises a step of controlling 717, by the data processing unit 10, the electric motor 12 so that the translatable command element 8 maintains the set second feed speed value V2 until reaching the first resting position.

In other words, also in this case, the data processing unit 10 performs the following (i.e. the feedback control) of the set second feed speed value V2, according to the previously described manner.

If the determined value IA representative of the electric current absorbed by the electric motor 10 during the operation thereof is equal to, or greater than the set reference absorption electric current value IAR, the method 700 comprises a step of interrupting 718, by the data processing unit 10, the power supply of the electric motor 12 so that the translatable command element 8 maintains the first resting position reached.

Therefore, the following (i.e. the feedback control) of the set second feed speed value V2 until reaching, by the translatable command element 8, the first resting position continues until the electric current absorbed by the electric motor 12 exceeds the set reference absorption electric current value IAR, which means, in other words, that the translatable command element 8 has effectively reached the resting position or “end-of-stroke”.

According to an embodiment, according to any one of the preceding ones, in the resting position of the translatable command element 8, the at least one door 4 is adapted to take a first operating configuration, in which it closes the front opening 3 of the compartment 2 of the body 1 of the piece of furniture 100.

In this embodiment, shown in the sequence of FIGS. 4a-4f, the method 700 is carried out by the data processing unit 10 to open the front opening 3 of the compartment 2 of the body 1 of the piece of furniture 100, by actuating the electric motor 12 to move the translatable command element 8 to displace it from the first resting position to the second operating position and then return to the first resting position again by pulling the at least one door 4 along the at least one guide 5 from the first linear segment L1 to the second linear segment L2 to switch from the first operating configuration to a second operating configuration, in which the at least one door 4 is housed inside the translatable command element 8 when the latter is back in the first resting position.

In said second operating configuration, the at least one door 4 is adapted to leave open the front opening 3 of the compartment 2 of the body 1 of the piece of furniture 100.

According to an embodiment, in combination with the preceding one, the method 700 comprises, during the step of opening the piece of furniture 100, a step of determining, by the data processing unit 10, information representative of the presence, or not, of an anomaly during the movement of the translatable command element 8, resulting in the at least one door 4 being pulled from the first resting position to the second operating position.

If there is an anomaly, the method 700 comprises a step of securing the piece of furniture 100, by the data processing unit 10, based on the type of anomaly detected.

By way of example, a first anomaly is the presence of an obstacle, e.g., a user, close to the piece of furniture 100, so as to interfere with the extending and folding movement of the at least one door 4 or of the translatable command element 8.

In this case, the presence of the anomaly can be determined by detecting a reduction in the determined value VA representative of the feed speed of the translatable command element 8 below a set threshold value (e.g., equal to 60 mm/s) or by detecting a sudden deceleration of the translatable command element 8, or, in the case of a substantially null feed speed, a sudden increase in the electric absorption current of the electric motor 12 can also mean the presence of an obstacle.

In the presence of this anomaly, the method includes inverting the direction of travel and bringing the translatable command element 8 back into the resting position.

A further anomaly can be the sudden interruption of the power supply.

In this case, the method 700 provides for the translatable command element 8 to be capable of moving under the action of the counterweight or being moved manually.

A further anomaly can be a sudden fault on the electronic board.

Also in this case, the method 700 includes interrupting the power supply of the electric motor 102, so that the translatable command element 8 can move under the action of the counterweight or be moved manually.

A further anomaly can be the crushing/shearing of an obstacle between the at least one door and the translatable command element 8 or the second door 4′ (if present).

Also in this case, the method 700 includes interrupting the power supply of the electric motor 102, so that the translatable command element 8 can move under the action of the counterweight or be moved manually.

A further anomaly can be a sudden fault on the encoder installed in the electric motor 12.

Also in this case, the method 700 includes interrupting the power supply of the electric motor 102, so that the translatable command element 8 can move under the action of the counterweight or be moved manually.

A further anomaly can be the breakage of the transmission belt.

Also in this case, the method 700 includes interrupting the power supply of the electric motor 102, so that the translatable command element 8 can be moved manually.

A further anomaly can be a blocking of the electric motor 12 cause fault (e.g., a short circuit state, an open circuit state, an electric current overload and so on).

In this case, the method 700 comprises steps of:
determining, by the data processing unit 10, information representative of a fault, resulting in the blocking of the electric motor 12;
interrupting, by the data processing unit 10, the power supply of the electric motor 102, so that the translatable command element 8 can continue to move from the second operating position to return to the first resting position, under the action of the counterweight or it can be moved manually.

If no anomaly is present, the translatable command element 8 continues to move from the first resting position to the second operating position.

According to an embodiment, in combination with the preceding one, the method 700 comprises, during the movement of the translatable command element 8 from the second operating position to return to the first resting position, a step of determining, by the data processing unit 10, information representative of the presence, or not, of an anomaly during the movement of the translatable command element 8, resulting in the at least one door 4 being pulled inside the translatable command element 8.

If there is an anomaly, the method 700 comprises a step of securing the piece of furniture 100, by the data processing unit 10, based on the type of anomaly detected.

Examples of anomalies and operations carried out by the method according to the type of anomaly detected were described previously.

If no anomaly is present, the translatable command element 8 continues to move to return to the first resting position again.

According to an embodiment, in combination with any of the preceding ones, in the resting position of the translatable command element 8, the at least one door 4 is adapted to take a first operating configuration, in which the at least one door 4 is accommodated in the translatable command element 8, in said first operating configuration the at least one door being adapted to leave open the front opening 3 of the compartment 2 of the body 1 of the piece of furniture 100.

In this embodiment, shown in the sequence of FIGS. 5a-5f, the method 700 is carried out by the data processing unit 10 to close the front opening 3 of the compartment 2 of the body 1 of the piece of furniture 100, moving the translatable command element 8 to displace it from the first resting position to the second operating position and then return to the first resting position again by pulling the at least one door 4 along the at least one guide 5 from the second linear segment L2 to the first linear segment L1 to switch from the first operating configuration to a second operating configuration, in which the at least one door 4 closes the front opening 3 of the compartment 2 of the body 1 of the piece of furniture 100.

According to an embodiment, in combination with the preceding one, the method 700 comprises, during the step of closing the piece of furniture 100, a step of determining, by the data processing unit 10, information representative of the presence, or not, of an anomaly during the movement of the translatable command element 8, resulting in the at least one door 4 being pulled from the first resting position to the second operating position.

If there is an anomaly, the method 700 comprises a step of securing the piece of furniture 100, by the data processing unit 10, based on the type of anomaly detected.

Examples of anomalies and operations carried out by the method according to the type of anomaly detected were described previously.

If no anomaly is present, the translatable command element 8 continues to move from the first resting position to the second operating position.

According to an embodiment, in combination with the preceding one, the method 700 comprises, during the movement of the translatable command element 8 from the second operating position to return to the first resting position again, a step of determining, by the data processing unit 10, information representative of the presence, or not, of an anomaly during the movement of the translatable command element 8, resulting in the at least one door 4 being pulled to close the front opening 3 of the compartment 2 of the body 1 of the piece of furniture 100.

If there is an anomaly, the method comprises a step of securing the piece of furniture 100, by the data processing unit 10, based on the type of anomaly detected.

Examples of anomalies and operations carried out by the method according to the type of anomaly detected were described previously.

if no anomaly is present, the translatable command element 8 continues to move to return to the first resting position again.

According to an embodiment, according to any one of the preceding ones, the piece of furniture 100 further comprises a second movable and oscillating door 4′ for opening or closing, together with the at least one door 4, the front opening 3 of the compartment 2.

In greater detail, the second door 4′ is operatively connected in an oscillating manner, e.g., by means of a hinge, to the at least one door 4 to be pulled, by the at least one door 4′, with respect to the front opening 3 during the movement of said translatable command element 8 for opening or closing said front opening 3.

In this embodiment, the piece of furniture 100 further comprises a second substantially L-shaped guide 5′ comprising a further first linear segment L1′ and a further second linear segment L2′, joined to each other.

The further first linear segment L1′ is parallel to the edge of the front opening 3, therefore, also to the first linear segment L1 of the at least one guide 5.

Also in this case, the further second linear segment L2′ is substantially orthogonal to the further first linear segment L1′ and is arranged at the outer side 6 of the body 1 of the piece of furniture 100 along the depth of the compartment 2.

In this embodiment, as shown in the figures, the upper edge of the at least one door 4 and the upper edge of the second door 4′ are slidingly coupled to the at least one guide 5 and to the second guide 5′ by means of the auxiliary coupling element 7.

In particular, the auxiliary coupling element 7 is adapted to slidingly engage with the at least one guide 5 by means of at least the first pin 7′ and with the second guide 5′ by means of the second pin 7″.

In greater detail, in this embodiment, as shown in the figures, the second door 4′ is secured to the auxiliary coupling element 7, while the at least one door 4 is indirectly connected to the auxiliary coupling element 7 by means of the connection thereof, e.g., by means of the hinge, to the second door 4′.

In the resting position of the translatable command element 8, the at least one door 4 and the second door 4′ are adapted to take a first operating configuration, in which they close the front opening 3 of the compartment 2 of the body 1 of the piece of furniture 100.

In this embodiment, shown in the sequence of FIGS. 4a-4f, the method 700 is carried out by the data processing unit 10 to open or close the front opening 3 of the compartment 2 of the body 1 of the piece of furniture 100, by actuating the electric motor 12 to move the translatable command element 8 to displace it from the first resting position to the second operating position and then return to the first resting position again by pulling the at least one door 4 and the second door 4′ along the at least one guide 5 from the first linear segment L1 to the second linear segment L2 and along the second guide 5′ from the further first linear segment L1′ to the further second linear segment L2′ to switch from the first operating configuration to a second operating configuration or vice versa.

In said second operating configuration, the at least one door 4 and the second door 4′ are folded and accommodated in the translatable command element 8 when the latter has returned to the first resting position.

In said second operating configuration, the at least one door 4 and the second door 4′ are adapted to leave open the front opening 3 of the compartment 2 of the body 1 of the piece of furniture 100.

With reference to the embodiments according to the present invention, the term “door” refers both to a door with a single stiff panel (not folding), but, alternatively, also to a door with a folding line thereof, adapted to define two or more regions, which are stiff but folding with respect to each other, e.g., by means of a hinge or folding line, which is locally more yielding with respect to the other areas of the door.

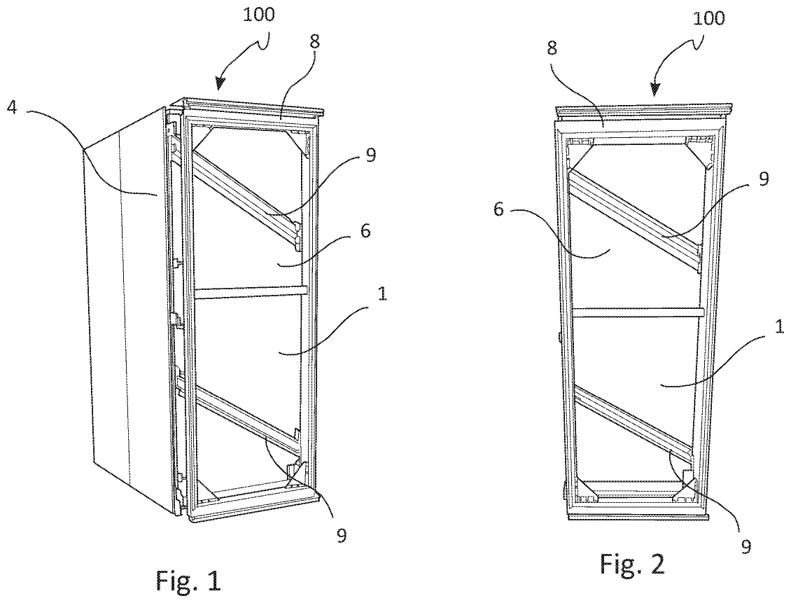

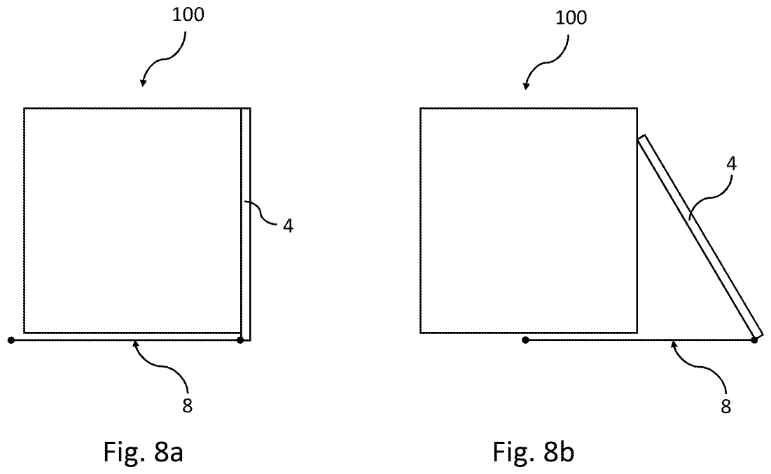

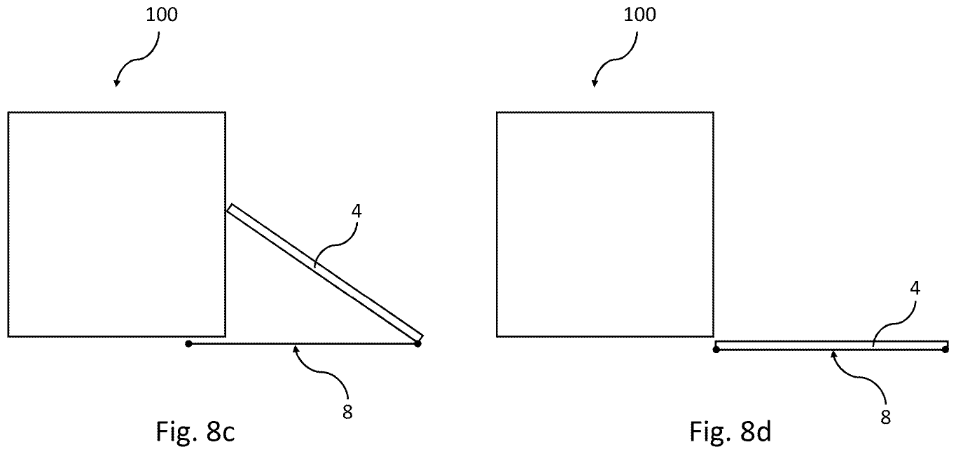

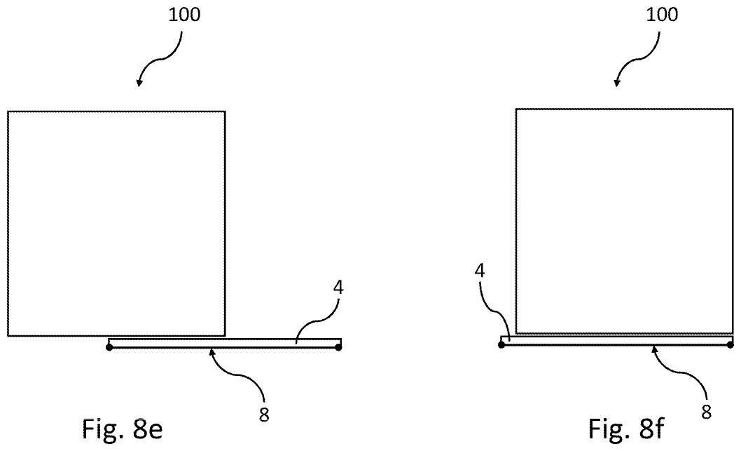

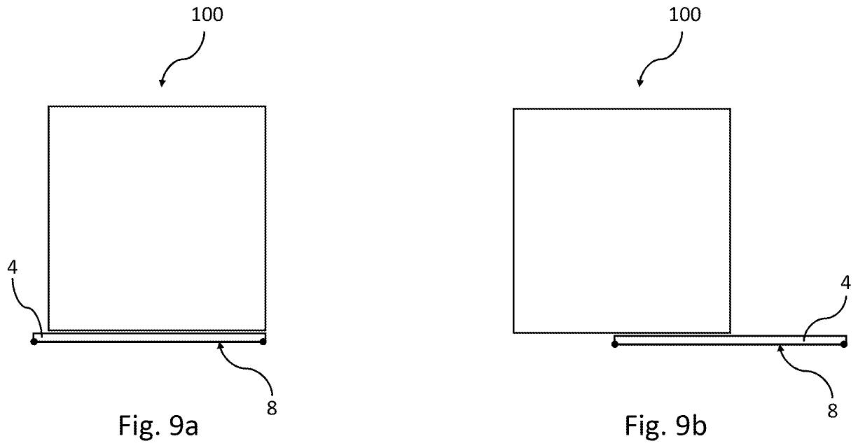

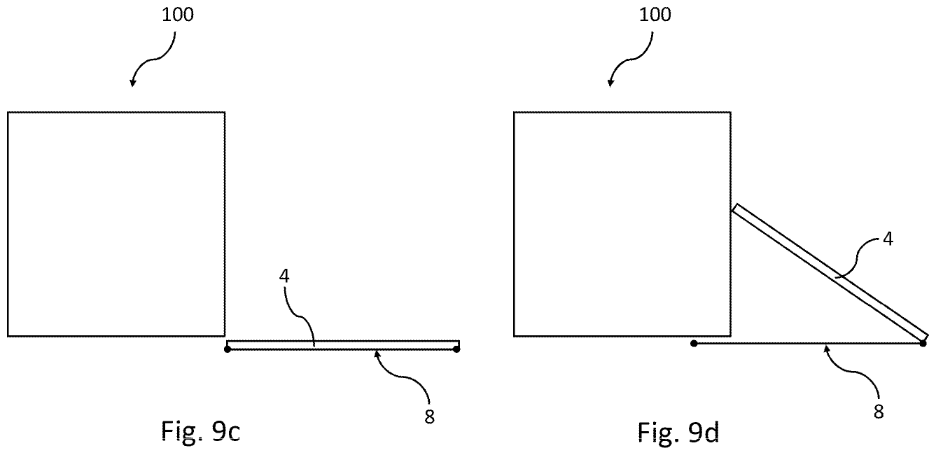

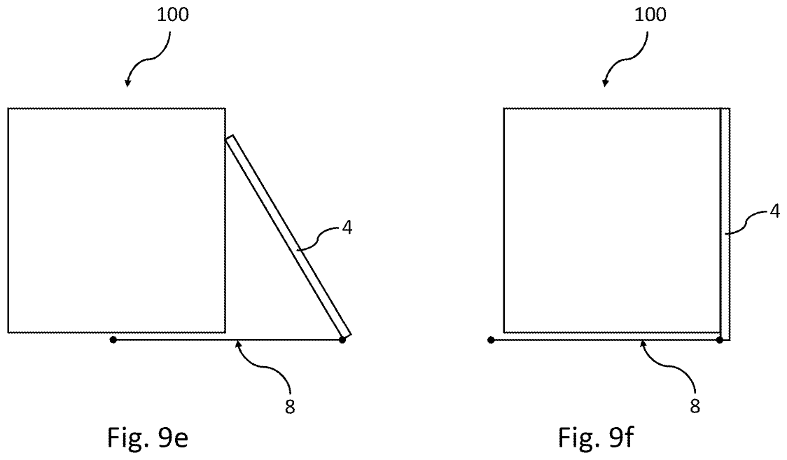

In this respect, FIGS. 8a-8f and 9a-9f are views diagrammatically showing the movement of a single door 4 with a single panel as an alternative to the embodiments in FIGS. 1, 2, 3a-3f, 4a-4f, 5a-5f, which, instead, show movements to be made by a plurality of doors 4, 4′ which are mutually oscillating and orientable, or by a single door 4 provided with at least one folding line.

In greater detail, FIGS. 8a-8f diagrammatically show top views of a further piece of furniture 100 according to the present invention, in successive operating configurations, during a step of opening the piece of furniture 100, wherein the single door 4 with a single panel is moved by the translatable command element 8 (described above with reference to the embodiments in FIGS. 1, 2, 3a-3f, 4a-4f, 5a-5f), to be pulled with respect to a front opening of the further piece of furniture 100 during the movement of said translatable command element 8 for opening said front opening.

. FIGS. 9a-9f diagrammatically show instead top views of the further piece of furniture 100 in successive operating configurations during a step of closing the further piece of furniture 100, wherein the single door 4 with a single panel is moved by the translatable command element 8 to be pulled with respect to the front opening of the further piece of furniture 100 during the movement of said translatable command element 8 for closing said front opening.

As can be noted, the object of the present invention is fully achieved as the method and the related piece of furniture described above have different advantages.

In fact, the method of the present invention is capable of recognizing the exceeding of the so-called “dead center”, which aspect is essential for the movement of the translatable command element to be complete and which is only achieved by bringing the at least one door close to the inversion point with a determined amount of kinetic energy.

The method allows uniformly controlling the movement of the translatable command element, avoiding sudden movements, which can damage the piece of furniture and create undesired noise.

The method also includes increasing the safety of the piece of furniture since specific actions are provided, to be put into practice if the presence of an anomaly is detected, from the presence of an obstacle to the normal movement of the at least one door (or doors) and/or the translatable command element to electrical faults, mechanical breakage of the components and other.

Those skilled in the art may make changes and adaptations to the embodiments of the method and the piece of furniture described above or replace elements with others which are functionally equivalent in order to meet contingent needs without departing from the scope of the following claims.

Each of the features described as belonging to a possible embodiment can be implemented irrespective of the other embodiments described.

1. A method of controlling an electric motor for moving at least one movable door of a piece of furniture the piece of furniture comprising:
a body adapted to define a compartment with a front opening;
at least one movable and oscillating door for closing the front opening of the compartment;
at least one substantially L-shaped guide comprising a first linear segment and a second linear segment joined to each other, the first linear segment being parallel to an edge of the front opening, the second linear segment being substantially orthogonal to the first linear segment and being arranged at an outer side of the body of the piece of furniture along the depth of the compartment, a side edge of the at least one door being slidingly coupled to the at least one guide by means of an auxiliary coupling element adapted to slidingly engage the at least one guide by means of at least a first pin; a command element translatable parallelly to and along said outer side the at least one door being operatively connected in an oscillating manner to the translatable command element to be pulled with respect to the front opening during the movement of said translatable command element for opening or closing said front opening;
a data processing unit;
an electric motor operatively connected to the translatable command element and to the data processing unit, said electric motor being commandable by the data processing unit to move the translatable command element,
the method comprising steps of:
moving, by the electric motor, the translatable command element upon the command received by the data processing unit at a set first feed speed value, from a first resting position in which the translatable command element is arranged in front of the outer side of the body of the piece of furniture and does not extend frontally from the piece of furniture ;
controlling, by the data processing unit the electric motor so that the translatable command element maintains the set first feed speed value
determining, by the data processing unit, a value representative of the distance covered by the translatable command element with respect to the first resting position, parallel to the outer side of the body of the piece of furniture;
comparing by the data processing unit, the detected value representative of the distance covered by the translatable command element with respect to the first resting position with a set first reference distance value to verify whether the translatable command element has reached a second operating position or not, in which such a translatable command element extends substantially at most frontally from the piece of furniture;
if the determined value representative of the distance covered by the translatable command element with respect to the first resting position is less than the set first reference distance value, controlling, by the data processing unit, the electric motor so that the translatable command element maintains the set first feed speed value;
if the determined value representative of the distance covered by the translatable command element with respect to the first resting position is equal to or greater than the set first reference distance value:
determining, by the data processing unit, a value representative of the feed speed of the translatable command element with respect to the first resting position;
comparing, by the data processing unit, the determined value representative of the feed speed of the translatable command element with respect to the first resting position with a set first reference speed value
if the determined value representative of the feed speed of the translatable command element with respect to the first resting position is greater than the set first reference speed value, controlling, by the data processing unit, the electric motor so that the translatable command element maintains the set first feed speed value
if the determined value representative of the feed speed of the translatable command element with respect to the first resting position is equal to or less than the set first reference speed value:
interrupting, by the data processing unit, the power supply of the electric motor so that the translatable command element moves, under the action of a counterweight, in the opposite direction from the second operating position towards the first resting position;
determining, by the data processing unit a value representative of the distance covered by the translatable element with respect to the second operating position;
comparing, by the data processing unit the determined value representative of the distance covered by the translatable command element with respect to the second operating position with a set second reference distance value;
if the determined value representative of the distance covered by the translatable command element with respect to the second operating position is greater than the set second reference distance value, keeping the power supply of the electric motor interrupted by the data processing unit,
if the determined value representative of the distance covered by the translatable element with respect to the second operating position is equal to or less than the set second reference distance value:
electrically powering, by the data processing unit, the electric motor to move the translatable command element towards the first resting condition;
controlling, by the data processing unit, the electric motor so that the translatable command element maintains a set second feed speed value until reaching the first resting position.

2. The method according to claim 1, wherein the step of controlling the electric motor so that the translatable command element maintains a set second feed speed value until reaching the first resting position comprises steps of:
determining, by the data processing unit, a value representative of the electric current absorbed by the electric motor during the operation thereof;
comparing, by the data processing unit, the determined value representative of the electric current absorbed by the electric motor during the operation thereof with a set reference absorption electric current value in order to establish whether the translatable command element has reached the first resting position or not,
if the determined value representative of the electric current absorbed by the electric motor during the operation thereof is less than the set reference absorption electric current value, controlling, by the data processing unit, the electric motor so that the translatable command element maintains the set second feed speed value until reaching the first resting position,
if the determined value representative of the electric current absorbed by the electric motor during the operation thereof is equal to or greater than the set reference absorption electric current value, interrupting, by the data processing unit, the power supply of the electric motor so that the translatable command element maintains the first resting position reached.

3. The method according to claim 1, wherein, in the resting position of the translatable command element, the at least one door is adapted to take a first operating configuration in which it closes the front opening of the compartment of the body of the piece of furniture, the method being carried out to open the front opening of the compartment of the body of the piece of furniture, by actuating the electric motor to move the translatable command element to displace it from the first resting position to the second operating position and then return to the first resting position again by pulling the at least one door along the at least one guide from the first linear segment to the second linear segment to switch from the first operating configuration to a second operating configuration in which the at least one door is accommodated inside the translatable command element. when the latter has returned to the first resting position, in said second operating configuration the at least one door being adapted to leave open the front opening of the compartment of the body of the piece of furniture.

4. The method according to claim 3, comprising, during the step of opening the piece of furniture, a step of determining, by the data processing unit, information representative of the presence, or not, of an anomaly during the movement of the translatable command element, resulting in the at least one door being pulled from the first resting position to the second operating position,
if there is an anomaly, the method comprises a step of securing the piece of furniture, by the data processing unit, based on the type of anomaly detected,
if no anomaly is present, the translatable command element continues to move from the first resting position to the second operating position.

5. The method according to claim 4, comprising, during the movement of the translatable command element from the second operating position to return to the first resting position again, a step of determining, by the data processing unit, information representative of the presence, or not, of an anomaly during the movement of the translatable command element, resulting in the at least one door being pulled inside the translatable command element,
if there is an anomaly, the method comprises a step of securing the piece of furniture, by the data processing unit, based on the type of anomaly detected,
if no anomaly is detected, the translatable command element continues to move to return to the first resting position again.

6. The method according to claim 1, wherein, in the resting position of the translatable command element, the at least one door is adapted to take a first operating configuration in which the at least one door is accommodated inside the translatable command element, in said first operating configuration the at least one door being adapted to leave open the front opening of the compartment of the body of the piece of furniture, the method being carried out by the processing unit to close the front opening of the compartment of the body of the piece of furniture moving the translatable command element to displace it from the first resting position to the second operating position and then return to the first resting position again by pulling the at least one door along the at least one guide from the second linear segment to the first linear segment to switch from the first operating configuration to a second operating configuration in which the at least one door closes the front opening of the compartment of the body of the piece of furniture.

7. The method according to claim 6, comprising, during the step of closing the piece of furniture, a step of detecting, by the data processing unit, information representative of the presence, or not, of an anomaly during the movement of the translatable command element resulting in the at least one door being pulled from the first resting position to the second operating position,
if there is an anomaly, the method comprises a step of securing the piece of furniture, by the data processing unit, based on the type of anomaly detected,
if no anomaly is detected, the translatable command element continues to move from the first resting position to the second operating position.

8. The method according to claim 7, comprising, during the movement of the translatable command element from the second operating position to return to the first resting position again, a step of determining, by the data processing unit, information representative of the presence, or not, of an anomaly during the movement of the translatable command element resulting in the at least one door being pulled to close the front opening of the compartment of the body of the piece of furniture,
if there is an anomaly, the method comprises a step of securing the piece of furniture, by the data processing unit, based on the type of anomaly detected,
if no anomaly is present, the translatable command element continues to move to return to the first resting position again.

9. The method according to claim 1, wherein the piece of furniture further comprises:
a second movable and oscillating door for opening or closing, together with the at least one door the front opening of the compartment, the second door being operatively connected in an oscillating manner to the at least one door to be pulled, by the at least one door, with respect to the front opening during the movement of said translatable command element for opening or closing said front opening;
a second substantially L-shaped guide comprising a further first linear segment and a further second linear segment joined to each other, the further first linear segment being parallel to the edge of the front opening, the further second linear segment being substantially orthogonal to the further first linear segment and being arranged at the outer side of the body of the piece of furniture along the depth of the compartment, the upper edge of the at least one door and the upper edge of the second door are slidingly coupled to the at least one guide and to the second guide by means of the auxiliary coupling element adapted to slidingly engage the at least one guide by means of the at least a first pin and the second guide by means of a second pin,
in the resting position of the translatable command element, the at least one door and the second door being adapted to take a first operating configuration in which they close the front opening of the compartment of the body of the piece of furniture,
the method being carried out by the data processing unit to open or close the front opening of the compartment of the body of the piece of furniture, by actuating the electric motor to move the translatable command element to displace it from the first resting position to the second operating position and then return to the first resting position again by pulling the at least one door and the second door along the at least one guide from the first linear segment to the second linear segment and along the second guide from the further first linear segment to the further second linear segment to switch from the first operating configuration to a second operating configuration or vice versa, in said second operating configuration, the at least one door and the second door being folded and housed inside the translatable command element when the latter has returned to the first resting position, in said second operating configuration the at least one door and the second door being adapted to leave open the front opening of the compartment of the body of the piece of furniture.

10. A piece of furniture comprising:
a body adapted to delimit a compartment with a front opening
at least one movable and oscillating door for closing the front opening
at least one substantially L-shaped guide comprising a first linear segment Hand a second linear segment joined to each other, the first linear segment being parallel to an edge of the front opening, the second linear segment being substantially orthogonal to the first linear segment and being arranged at an outer side of the piece of furniture along the depth of the compartment, a side edge of the at least one door being slidingly coupled to the at least one guide by means of an auxiliary coupling element adapted to slidingly engage the at least one guide by means of at least a first pin;
a command element translatable parallelly to and along said outer side the at least one door being operatively connected in an oscillating manner to the translatable command element to be pulled with respect to the front opening during the movement of said translatable command element for opening or closing said front opening;
a data processing unit;
an electric motor operatively connected to the translatable command element and to the data processing unit, said electric motor being commandable by the data processing unit to move the translatable command element
the data processing unit being configured to carry out the steps of the method according to claim 1.

11. A piece of furniture according to claim 10, further comprising:
a second movable and oscillating door for opening or closing, together with the at least one door, the front opening of the compartment the second door being operatively connected in an oscillating manner to the at least one door to be pulled, by the at least one door with respect to the front opening during the movement of said translatable command element for opening or closing said front opening;
a second substantially L-shaped guide comprising a further first linear segment and a further second linear segment joined to each other, the further first linear segment being parallel to the edge of the front opening, the further second linear segment being substantially orthogonal to the further first linear segment and being arranged at the outer side of the body of the piece of furniture along the depth of the compartment, the upper edge of the at least one door and the upper edge of the second door are slidingly coupled to the at least one guide and to the second guide by means of the auxiliary coupling element adapted to slidingly engage the at least one guide by means of the at least a first pin and the second guide by means of a second pin; in the resting position of the translatable command element, the at least one door and the second door being adapted to take a first operating configuration in which they close the front opening of the compartment of the body of the piece of furniture.
